(19) United States
(12) Patent Application Publication
(10) Pub. No.: US 2009/0136367 A1
(43) Pub. Date: May 28, 2009

(54) Air compressor

(75) Inventors: Tomotake Sakaguchi, Shizuoka (JP); Yuji Kamiya, Shizuoka (JP); Keito Chiba, Shizuoka (JP); Tomoyuki Kado, Shizuoka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Industrial Equipment Systems Co., Ltd., Tokyo (JP)

(21) Appl. No.: 12/220,226

(22) Filed: Jul. 22, 2008

(30) Foreign Application Priority Data
Nov. 28, 2007 (JP) 2007-307962

(51) Int. Cl. F04D 25/06; F16H 7/08

(52) U.S. Cl. 417/359; 417/362; 474/101

(57) ABSTRACT

Provided is an air compressor that can keep good alignment between pulleys 2b and 3b respectively of a compressor body and an electric motor, and a drive belt 4 placed thereacross.

Between a base 1 and the electric motor 3, an adjustment mechanism 5 is provided for adjusting the tension of the drive belt 4 by changing the relative position between the compressor body 2 and the electric motor 3. The adjustment mechanism 5 is provided with an electric-motor base 6 for supporting the electric motor, a support unit 7 that supports the electric-motor base 6 to allow a tilting axis thereof to be able to tilt at a position lower of an output shaft of the electric motor, and fixing unit 8 provided between an end of the electric-motor base 6 and the base 1 for fixing the electric-motor base 6 in a tilting state.

### CLAIM OF PRIORITY

The present application claims priority from Japanese application serial no. JP2007-307962, filed on Nov. 28, 2007, the content of which is hereby incorporated by reference into this application.

### BACKGROUND OF THE INVENTION

1. Field of the Invention

The present invention relates to an air compressor that transmits the rotation of an electric motor to a compressor disposed in line using a drive belt placed across pulleys and, more specifically, to an air compressor that can adjust the tension of a drive belt placed across an electric motor and a compressor driven by the electric motor.

2. Description of the Related Art

In an air compressor whose compressor body is to be driven by the rotation of an electric motor, a transmission mechanism using coupling, gear, and belt and pulley, or others has been generally used as means for transmitting the rotation of the electric motor to the compressor body. The mechanism with coupling is of a configuration in which the shaft of an electric motor is directly coupled with the shaft of a compressor body, thereby enabling efficient operation with a considerably small transmission loss of power.

However, such a mechanism requires attention for the assembly work because if the shaft of the electric motor is not aligned precisely enough with the shaft of the compressor body, any excessive vibration occurs, for example. The mechanism is thus not considered simple and easy to use. The mechanism with gear indeed leads to the high transmission efficiency when used with an electric motor with relatively high output. However, a problem of noise often occurs due to gear meshing during driving, and there is also a drawback of requiring cost and time for manufacturing of the gears.

On the other hand, the power transmission mechanism with belt and pulley, i.e., a belt is placed across an electric motor pulley and a compressor body pulley, is suitable for electric motors with a low to medium output. Although this mechanism with belt and pulley is somewhat inferior in terms of transmission efficiency compared to the above-described mechanisms with gear and coupling, there are many advantages such as good workability of assembly and high layout flexibility of an electric motor and a compressor body, and thus the mechanism has been popularly used.

Such a power transmission mechanism with belt and pulley requires a system for adjusting the tension of the belt. As an example, there is a system of supporting one end of an electric motor rack to be able to rotate, and providing positioning means such as double nut to the other end side of the electric motor rack. An example includes Patent Document 1 (JP-A-6-346881 (paragraphs 0018 to 0023, and FIG. 1).

### SUMMARY OF THE INVENTION

In the belt-tension adjustment system described above, an electric motor or a compressor is disposed on a tiltable rack, and the distance between their shafts is changed while keeping the shafts parallel, thereby being able to adjust the tension of the belt with relative ease.

The concern here is that, in such a belt-tension adjustment system, the rack carrying thereon the heavy electric motor is supported at one end to be able to rotate. With such a configuration, if the electric motor is pulled with a strong force during adjustment of the belt, the rack is put under the action of high moment about the rotation axis. As a result, the rotation axis is put under the eccentric load, and the load-imposed portion is deformed and meshed, for example. In extreme cases, the rack may be deformed.

If such a phenomenon occurs, a displacement is observed on the rotation surface between the pulley of the electric motor and that of the compressor, and thus the alignment is lost between the pulleys and the belt, thereby problematically encouraging the damage to the belt. If the rotation axis area of the rack is deformed, the rack may fail to tilt during adjustment of the belt.

The invention is proposed based on the problems as such, and an object thereof is to provide an air compressor that can keep good alignment among a pulley of a compressor body, a pulley of an electric motor, and a drive belt placed across the pulleys.

In order to achieve the object above, a first aspect of the invention is directed to an air compressor in which power of an electric motor is transmitted to a compressor body by a drive belt placed across a pulley of a rotation shaft of the compressor body and a pulley of an output shaft of the electric motor. The air compressor includes: an adjustment mechanism between a base and the electric motor for adjusting tension of the drive belt by changing a relative position between the compressor body and the electric motor. In the air compressor, the adjustment mechanism includes: an electric-motor base that supports the electric motor; a support unit that supports the electric-motor base to allow a tilting axis thereof to be able to tilt at a position lower of an output shaft of the electric motor; and a fixing unit provided between an end of the electric-motor base and the base for fixing the electric-motor base in a tilting state.

According to a second aspect of the invention, in the first aspect, characteristically, the support unit that supports the electric-motor base to be able to tilt includes: a support shaft provided to a side-to-side middle portion of the electric-motor base to be orthogonal to a shaft direction of an output shaft of the electric motor; and a support bracket fixed to the base to support the support shaft.

According to a third aspect of the invention, in the first or second aspect, characteristically, the fixing unit that fixes the electric-motor base in the tilting state includes: a support bolt whose one end is supported by the base to be able to rotate, and the other end is engaged with the one end of the electric-motor base; and adjustment nuts respectively screwed into the support bolt to come in contact with surfaces of the electric-motor base on the one end.

According to a fourth aspect of the invention, in the first or second aspect, characteristically, the fixing unit that fixes the electric-motor base in the tilting state includes: support bolt whose one end is supported by the base to be able to rotate, and the other end is engaged with the one end of the electric-motor base; adjustment nuts respectively screwed into the support bolt to come in contact with an upper surface of the electric-motor base on the one end; and a spring provided to a bottom surface of the electric-motor base on the one end.

According to a fifth aspect of the invention, in any of the first to fourth aspects, a compressor to be disposed in line with the electric motor is fixed above the base by a rack.

According to a sixth aspect, in any of the first to fourth aspects, characteristically, a compressor to be disposed in line with the electric motor is fixed above the base by a rack, and the electric motor, the electric-motor base, the support unit, and the fixing unit are disposed in the rack of the compressor.

According to the aspects of the invention, a tilt axis of the electric-motor base can be disposed below the output shaft of the electric motor placed on the electric-motor base. This accordingly enables to reduce the moment about the tilt axis of the electric motor as a result of the adjustment of the tension of the belt, thereby preventing deformation of the electric-motor base. As such, alignment can be kept good among a pulley of a compressor body, a pulley of an electric motor, and a drive belt placed across the pulleys.

### BRIEF DESCRIPTION OF THE DRAWINGS

FIG. 1 is a system diagram of an air compressor in one embodiment of the invention;

FIG. 2 is a front view of the air compressor in the embodiment of the invention;

FIG. 3 is a plan view of the air compressor of FIG. 1;

FIG. 4 is a side view of the air compressor of FIG. 1, viewed from the left side;

FIG. 5 is a front view of an air compressor in another embodiment of the invention; and

FIG. 6 is a front view of an air compressor in still another embodiment of the invention.

### DETAILED DESCRIPTION OF PREFERRED EMBODIMENTS

In the below, air compressors in embodiments of the invention are described by referring to the accompanying drawings.

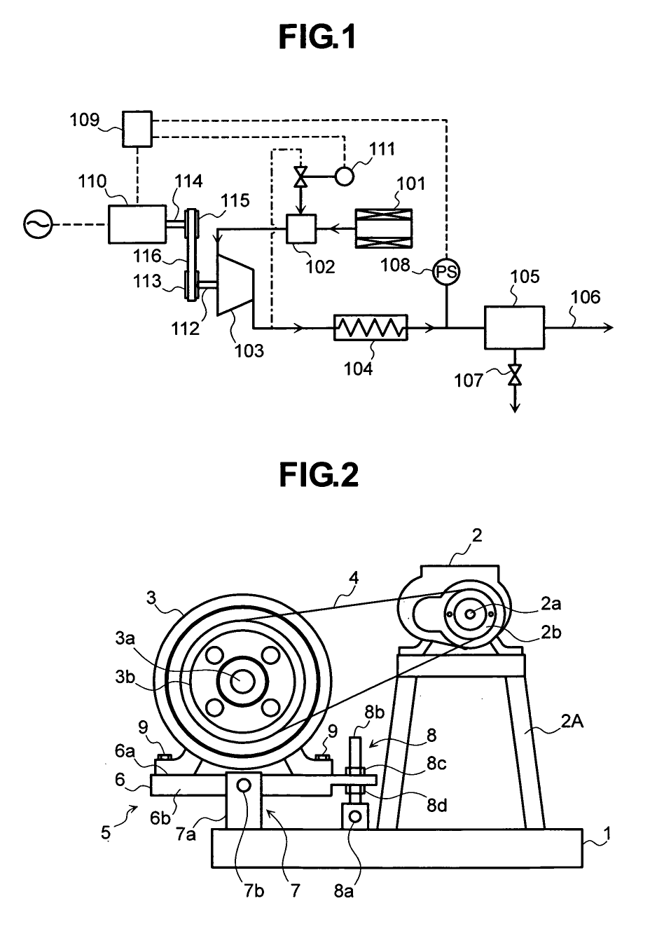

FIG. 1 is a system diagram of an air compressor in an embodiment of the invention. In FIG. 1, air at atmospheric pressure, i.e., air flow for compression, is directed into a compressor body 103 via a suction filter 101 and a suction valve 102, and is compressed in the compressor body 103 down to a predetermined pressure value. The resulting air is cooled in a heat exchanger 104, is dehumidified by a dehumidifier 105, and then is discharged from a compressed air discharge port 106. The condensed moisture as a result of separation in the dehumidifier 105 is emitted outside after passing through a condensed water emission solenoid valve 107. The value of a pressure sensor 108 is used as a basis to determine in what load state the compressor body 103 is. The value of the pressure sensor 108 is also used by control unit 109 to control an electric motor 110 over its drive speed, and to open and close the suction valve 102 via a solenoid valve 111, for example, whereby the compressor body 103 can remain in the optimum operation state. The compressor body 103 is driven by a belt 116, which is placed across a pulley 113 of a rotation shaft 112 thereof and a pulley 115 of an output shaft 114 of the electric motor 110.

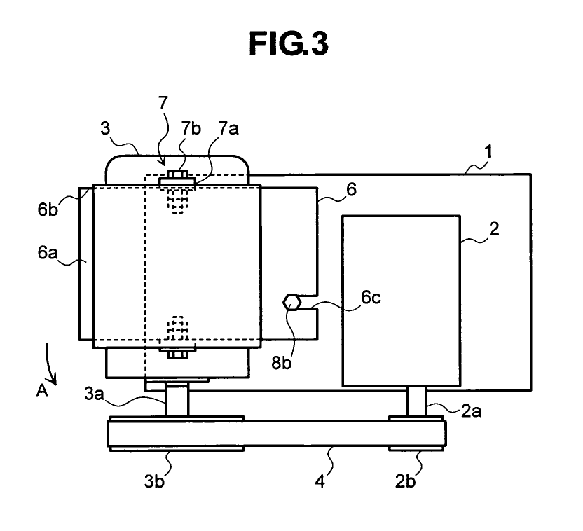

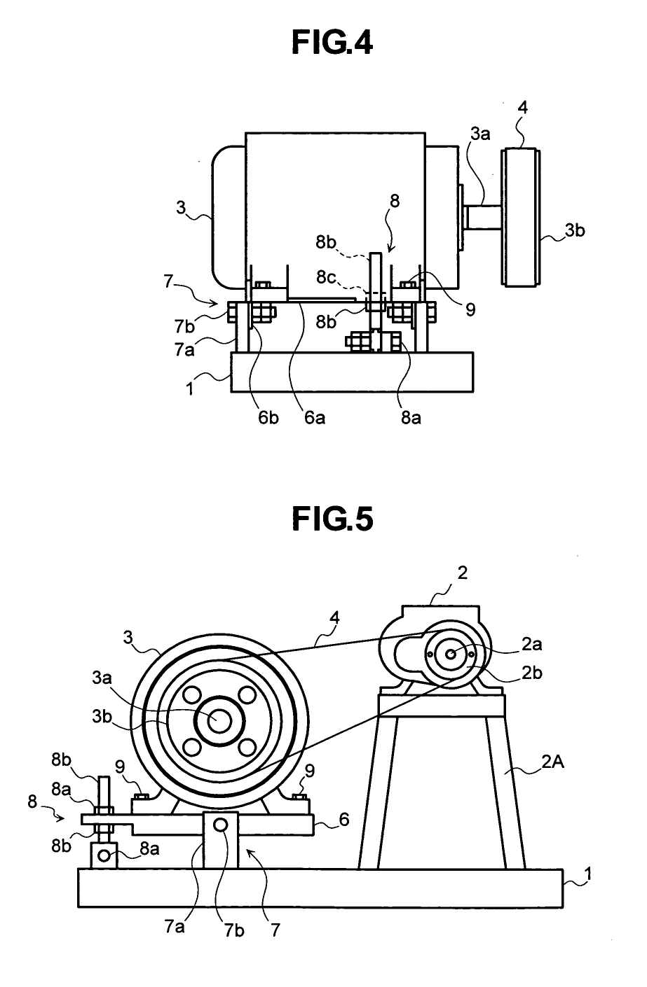

FIGS. 2 to 4 each show an air compressor in the embodiment of the invention, i.e., FIG. 2 is a front view of the air compressor in the embodiment of the invention, FIG. 3 is a plan view of the air compressor of FIG. 2, and FIG. 4 is a left side view of the air compressor of FIG. 2. In these drawings, a reference numeral 1 denotes a base, and a reference numeral 2 denotes a compressor body disposed on the base 1 via a rack 2A therebetween. This compressor body 2 corresponds to the compressor body 103 of FIG. 1. The compressor body 2 is configured to include a casing, and a male/female rotor (not shown) housed in this casing. Through rotation of the rotor, air compression is performed. A rotation shaft 2a of the compressor body 2, i.e., corresponding to the component in FIG. 1 with the reference numeral 112, is provided with a pulley 2b, i.e., corresponding to the component in FIG. 1 with the reference numeral 113.

A reference numeral 3 denotes an electric motor for use to drive the compressor body 2, and this electric motor 3 is disposed on the side of the compressor body 2 of FIG. 2. A rotation axis 3a of the electric motor 3, i.e., corresponding to the component in FIG. 1 with the reference numeral 114, is fixed with a pulley 3b, i.e., corresponding to the component in FIG. 1 with the reference numeral 115. Across this pulley 3b and the pulley 2b on the side of the compressor body 2, a drive belt 4, i.e., corresponding to the component of FIG. 1 with the reference numeral 116, is placed for transmitting the power of the electric motor 3 to the compressor body 2.

Between the electric motor 3 and the base 1, an adjustment mechanism 5 is provided for adjusting the tension of the drive belt 4 by changing the relative position between the compressor body 2 and the electric motor 3. The adjustment mechanism 5 is configured to include an electric-motor base 6 for supporting the electric motor 3, support unit 7, and fixing unit 8. The rotation axis of the electric-motor base 6 is disposed directly below the output shaft 3a of the electric motor 3, and the support unit 7 serves to support the electric-motor base 6 to be able to tilt. The fixing unit 8 fixes the electric-motor base 6 at its one end to be in the tilting state. The electric-motor base 6 is configured to include a support portion 6a, and a flange 6b. The support portion 6a is provided for supporting the electric motor 3, and the flange 6b is provided to each of the side surfaces of the support portion 6a, i.e., surfaces parallel to the diagram of FIG. 1. Above the support portion 6a of the electric-motor base 6, the electric motor 3 is fixed using a bolt 9.

The support unit 7 configures a tilt axis of the electric-motor base 6 below the output shaft 3a of the electric motor 3. Such support unit 7 is provided with a support bracket 7a and a shaft 7b. The support bracket 7a is so fixed on the base 1 as to be located at the middle portion, in the longitudinal direction, of each of the flanges 6b of the electric-motor base 6. The shaft 7b is for coupling the flanges 6b of the electric-motor base 6 to the support bracket 7a. This shaft 7b can be configured by a bolt and a nut, and can support the electric-motor base 6 to be able to tilt by bolt insertion and nut screwing, e.g., a bolt is inserted to a hole formed to the support bracket 7a and a hole formed to each of the flanges 6b of the electric-motor base 6, and a nut is screwed into each of these bolts.

In the fixing unit 8 for use to fix the electric-motor base 6 in the tilting state is configured to include a support bolt 8b, and upper and lower adjustment nuts 8c and 8d. In the support bolt 8b, one end, i.e., lower end, is supported by the base 1 using a pin shaft 8a to be able to rotate, and the other end, i.e., upper end, is engaged with a notch portion 6c (refer to FIG. 3) provided at one end of the support portion 6a of the electric-motor base 6, i.e., right end side of FIG. 2. The adjustment nuts 8c and 8d are respectively screwed into the support bolt 8b in such a manner as to come in contact with the surfaces at one end of the support portion 6a of the electric-motor base 6.

Described next is the operation of the above-described air compressor in the embodiment of the invention.

The power, i.e., rotation, of the electric motor 3 driving the compressor body 2 is transmitted from the pulley 3b of the electric motor 3 to the pulley 2b of the compressor body 2 via the drive belt 4. The rotation frequency of the compressor body 2 is determined by the diameter ratio between the pulleys 2b and 3b. With such transmission of power, the compressor body 2 is accordingly driven so that air is compressed and supplied thereby.

For replacing the drive belt 4 with a new one because the drive belt 4 became loose with time, the upper and lower adjustment nuts 8c and 8d screwed into the support bolt 8b as a part of the adjustment mechanism 5 are moved downward along the support bolt 8b. As a result, one end (right end in FIG. 2) of the electric-motor base 6 is tiled clockwise in FIG. 2 about the shaft 7b.

This accordingly enables to move the electric motor 3 on the electric-motor base 6 to the side of the compressor body 2, and thus the distance between the shafts of the pulleys 2b and 3b is reduced, thereby being able to remove the drive belt 4 from the pulleys 2b and 3b. Thereafter, for attachment of the new drive belt 4 to the pulleys 2b and 3b, the drive belt 4 is first placed across the pulleys 2b and 3b. Thereafter, the upper and lower adjustment nuts 8c and 8d screwed into the support bolt 8b are moved in the opposite direction from the above-described direction, i.e., upward, along the support bolt 8b. As a result, one end of the electric-motor base 6, i.e., right end in FIG. 2, is tiled counterclockwise in FIG. 2 about the shaft 7b.

This accordingly enables to move the electric motor 3 on the electric-motor base 6 in the direction away from the compressor body 2, and thus the distance between the shafts of the pulleys 2b and 3b is increased, thereby being able to provided the tension to the drive belt 4.

During adjustment of the tension for the drive belt 4 in the adjustment mechanism 5, the support unit 7 is put under the action of the moment in the counterclockwise direction, i.e., the direction of an arrow A of FIG. 3, but the moment acting on the portion of the tilt axis, i.e., shaft 7b, of the electric-motor base 6 in the support unit 7 becomes smaller than that in the previous configuration. This is because, unlike the previous tilt shaft disposed at one end side of the electric-motor base 6, the shaft 7b is located below the output shaft 3a of the electric-motor 3. As such, without making solid the configuration of the adjustment mechanism 5, the tension of the driving belt 4 can be adjusted while the alignment can remain good between the pulleys 2b and 3b respectively of the compressor body 2 and the electric motor 3 and the drive belt 4 placed thereacross.

When the drive belt 4 becomes loose with time, as described above, the upper and lower adjustment nuts 8c and 8d screwed into the support bolt 8b are moved upward along the support bolt 8b. As a result of such a movement, one end of the electric-motor base 6, i.e., right end in FIG. 2, is tiled counter clockwise in FIG. 2 about the shaft 7b.

As a result, the electric motor 3 on the electric-motor base 6 can be moved in the direction away from the compressor body 2, and thus the distance between the shafts of the pulleys 2b and 3b is increased, thereby being able to provided the tension to the drive belt 4.

Also in this case, similarly to the above, during adjustment of the tension for the drive belt 4 by the adjustment mechanism 5, the tension of the driving belt 4 can be adjusted while the alignment can remain good between the pulleys 2b and 3b respectively of the compressor body 2 and the electric motor 3 and the drive belt 4 placed thereacross.

With the embodiment of the invention described above, the alignment can remain good between the pulleys 2b and 3b respectively of the compressor body 2 and the electric motor 3 and the drive belt 4 placed thereacross. With good alignment achieved as such, the pulleys 2b and 3b become able to fully abut the drive belt 4, thereby increasing the life expectancy of the drive belt 4. Also during replacement of the drive belt 4, the alignment can remain good between the pulleys 2b and 3b respectively of the compressor body 2 and the electric motor 3 and the drive belt 4 placed thereacross, thereby considerably reducing the time needed for the replacement work.

Also with the embodiment of the invention described above, during adjustment of the tension for the drive belt 4, the moment acting on the adjustment mechanism 5 about the support unit 7 can be reduced. This accordingly eliminates the need for making solid the adjustment mechanism 5 including the electric-motor base 6, whereby the resulting configuration can be lightweight and simple.

Further, with the embodiment of the invention described above, the fixing unit 8 is disposed on the base 1 between the electric motor 3 and the rack 2A for fixing the electric-motor base 6 in the tilting state. As a result, the base is reduced in size, thereby reducing also the space occupied therewith.

FIG. 5 is a front view of an air compressor of another embodiment of the invention. In FIG. 5, any component sharing the same reference numeral as that in FIG. 2 means the same thereas, and thus is not described in detail again. In this embodiment, a function is additionally provided for preventing any possible tension reduction due to wear and tear of the drive belt 4 with time, i.e., a spring 10 is provided between the lower surface of the electric-motor base 6 on one end side and the lower adjustment nut 8d.

In such an embodiment, for providing the drive belt 4 with tension, similarly to the embodiment described above, the upper and lower adjustment nuts 8c and 8d are moved upward along the support bolt 8b. As a result of such a movement, one end of the electric-motor base 6, i.e., right end in FIG. 2, is tiled counter clockwise in FIG. 5 about the shaft 7b. At this time, the spring 10 is compressed in accordance with the movement amount of the lower adjustment nut 8d, i.e., spring 10 is compressed appropriately in the state that the drive belt 4 is provided with any desired level of tension.

Thereafter, as the operation of the compressor body 2 by the electric motor 3 is continued, the drive belt 4 starts wearing out by degrees. However, the degree of wear and tear is used as a basis to reduce the compression level of the spring 10 so that one end of the electric-motor base 6, i.e., right end of FIG. 5, is pushed upward, thereby preventing any reduction of tension of the drive belt 4 possibly caused by wear and tear thereof with time.

With this embodiment, the effects similar to those of the embodiment described above can be derived, and the drive belt 4 can make full use of its own function of automatic tension adjustment, thereby favorably reducing the checking frequency for the drive belt 4 in terms of tension.

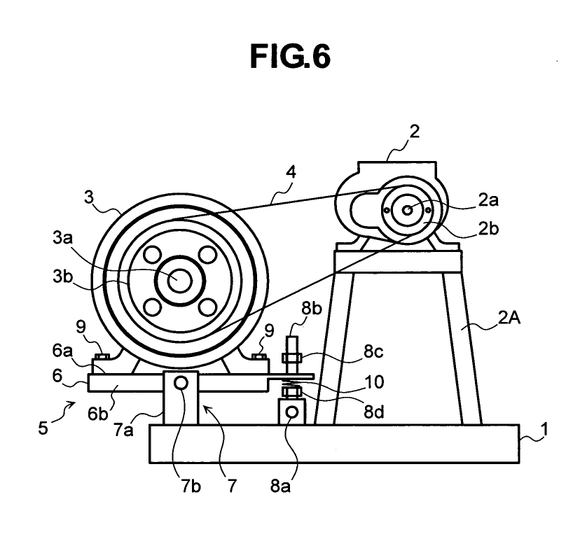

Note that, in the embodiment described above, in FIG. 2, the fixing unit 8 is disposed at one end of the electric-motor base 6, i.e., right end of FIG. 2, for fixing the electric-motor base 6 in the tilting state. Alternatively, as shown in FIG. 6, the fixing unit 8 may be provided at the other end of the electric-motor base 6, i.e., left end of FIG. 6. If this is the configuration, because the fixing unit 8 is located at the other end of the electric-motor base 6, i.e., left end of FIG. 6, the adjustment workability can be accordingly increased.

In the embodiment described above, the compressor body is disposed on the rack 2A to be in line with the above-described adjustment mechanism 5 including the electric motor 3, the electric-motor base 6, the support unit 7, and the fixing unit 8. If the layout allows, the electric motor 3 and the adjustment mechanism 5 may be disposed inside of the rack 2A.

What is claimed is:

1. An air compressor in which power of an electric motor is transmitted to a compressor body by a drive belt placed across a pulley of a rotation shaft of the compressor body and a pulley of an output shaft of the electric motor, the air compressor comprising:
an adjustment mechanism between a base and the electric motor for adjusting tension of the drive belt by changing a relative position between the compressor body and the electric motor, wherein
the adjustment mechanism includes:
an electric-motor base that supports the electric motor;
a support unit that supports the electric-motor base to allow a tilting axis thereof to be able to tilt at a position lower of an output shaft of the electric motor; and
a fixing unit provided between an end of the electric-motor base and the base for fixing the electric-motor base in a tilting state.

2. The air compressor according to claim 1, wherein
the support unit that supports the electric-motor base to be able to tilt includes:
a support shaft provided to a side-to-side middle portion of the electric-motor base to be orthogonal to a shaft direction of an output shaft of the electric motor; and
a support bracket fixed to the base to support the support shaft.

3. The air compressor according to claim 1 or 2, wherein
the fixing unit that fixes the electric-motor base in the tilting state includes:
a support bolt whose one end is supported by the base to be able to rotate, and the other end is engaged with the one end of the electric-motor base; and
adjustment nuts respectively screwed into the support bolt to come in contact with surfaces of the electric-motor base on the one end.

4. The air compressor according to claim 1 or 2, wherein
the fixing unit that fixes the electric-motor base in the tilting state includes:
a support bolt whose one end is supported by the base to be able to rotate, and the other end is engaged with the one end of the electric-motor base;
adjustment nuts respectively screwed into the support bolt to come in contact with an upper surface of the electric-motor base on the one end; and
a spring provided to a bottom surface of the electric-motor base on the one end.

5. The air compressor according to claim 1 or 2, wherein
a compressor to be disposed in line with the electric motor is fixed above the base by a rack.

6. The air compressor according to claim 3, wherein
a compressor to be disposed in line with the electric motor is fixed above the base by a rack.

7. The air compressor according to claim 4, wherein
a compressor to be disposed in line with the electric motor is fixed above the base by a rack.

8. The air compressor according to claim 1 or 2, wherein
a compressor to be disposed in line with the electric motor is fixed above the base by a rack, and
the electric motor, the electric-motor base, the support unit, and the fixing means are disposed in the rack of the compressor.

9. The air compressor according to claim 3, wherein
a compressor to be disposed in line with the electric motor is fixed above the base by a rack, and
the electric motor, the electric-motor base, the support unit, and the fixing unit are disposed in the rack of the compressor.

10. The air compressor according to claim 4, wherein
a compressor to be disposed in line with the electric motor is fixed above the base by a rack, and
the electric motor, the electric-motor base, the support unit, and the fixing unit are disposed in the rack of the compressor.
